(19) United States
(12) Patent Application Publication
(10) Pub. No.: US 2015/0012846 A1
(43) Pub. Date: Jan. 8, 2015

(54) Method, System and Mobile Terminal for Deleting Chat Record

(71) Applicant: Tencent Technology (Shenzhen) Company Limited, Shenzhen (CN)

(72) Inventor: Dong Xie, Shenzhen (CN)

(21) Appl. No.: 14/491,623

(22) Filed: Sep. 19, 2014

Related U.S. Application Data
(63) Continuation of application No. PCT/CN2014/071203, filed on Jan. 23, 2014.

(30) Foreign Application Priority Data
May 14, 2013 (CN) 201310177213.7

(51) Int. Cl. G06F 3/0484; H04L 29/08; G06F 3/0481

(52) U.S. Cl. CPC G06F 3/04847; G06F 3/0481; G06F 3/04842; H04L 67/10
USPC 715/753

(57) ABSTRACT

A method, system and mobile terminal for deleting a chat record are provided. The method includes: receiving an instruction for deleting the chat record; and deleting the chat record in responding to instruction. By implementing the technical solution according to the embodiment of the present disclosure, it is able to selectively delete chat records, thus prevent losses of a user.

This application claims priority to and is a continuation of PCT/CN2014/071203, filed on Jan. 23, 2014 and entitled “METHOD, SYSTEM AND MOBILE TERMINAL FOR DELETING CHAT RECORD”, which claims priority to Chinese Patent Application No. 201310177213.7, entitled “METHOD, SYSTEM AND MOBILE TERMINAL FOR DELETING CHAT RECORD”, tiled with State Intellectual Property Office of PRC on May 14, 2013, which are incorporated herein by reference in their entireties.

### FIELD

The present disclosure relates to the field of internet technology, and particularly to a method, a system and a mobile terminal for deleting a chat record.

### BACKGROUND

Currently, the number of users who chat with other by using an instant messenger provided by a mobile terminal is increasing. Consequently, the chat records are increasingly abundant. In order to effectively release the memory space of the mobile terminal occupied by the chat records, the users often need to delete the chat records from the mobile terminal. In practice, the deletion of the chat records from the mobile terminal by users is all achieved in the form of batch deletion, for example, the users may delete all of the chat records in a certain friend, a group or a discussion group in batches.

However, in practice, it is found that the method for deleting the chat records in batches is deleting all of the chat records at one time. For some of more important chat records (e.g. telephone number, address information and the like sent by somebody), they are deleted at the same time, causing losses of the users.

### SUMMARY OF THE INVENTION

Embodiments of the present disclosure disclose a method, a system and a mobile terminal for deleting a chat record, by which chat records can be deleted selectively, thus causing losses to the user can be prevented.

An embodiment of the present disclosure discloses a method for deleting a chat record, including:

receiving an instruction for deleting the chat record; and

deleting the chat record in responding to the instruction.

An embodiment of the present disclosure discloses a system for deleting a chat record, including:

a receiving unit, configured to receive an instruction for deleting the chat record; and

a responding and deleting unit, configured to delete the chat record in responding to the instruction.

An embodiment of the present disclosure discloses a mobile terminal, which includes the system for deleting a chat record according to the embodiments of the invention.

In the embodiments of the present disclosure, when the system receives an instruction for deleting a chat record, the system may respond to delete the chat record in responding to the instruction. Therefore, compared with the prior art in which the chat records are deleted in batches, the embodiments of the present disclosure can selectively delete chat records, and thus can prevent losses of a user.

### BRIEF DESCRIPTION OF THE DRAWINGS

In order to more clearly illustrate the technical solution in the embodiments of the present disclosure, drawings which are needed to use in the embodiments are described below simplify. Obviously, the drawings described below are merely some embodiments of the present disclosure, and for those skilled in the art, other drawings can be obtained based on these drawing without creative efforts.

FIG. 1 is a flowchart of a method for deleting a chat record according to an embodiment of the present disclosure;

FIG. 2 is a flowchart of another method for deleting a chat record according to an embodiment of the present disclosure;

FIG. 3 is a flowchart of another method for deleting a chat record according to an embodiment of the present disclosure;

FIG. 4 is a schematic diagram showing a case where an instant messenger chat interface is being operated, according to an embodiment of the present disclosure;

FIG. 5 is a schematic diagram showing the instant messenger chat interface shown in FIG. 3 after being operated;

FIG. 6 is a structure diagram of a system for deleting a chat record according to an embodiment of the present disclosure;

FIG. 7 is a structure diagram of another system for deleting a chat record according to an embodiment of the present disclosure; and

FIG. 8 is a structure diagram showing a mobile terminal according to an embodiment of the present disclosure.

### DETAILED DESCRIPTION

The embodiments of the present disclosure will be clearly and completely described below in conjunction with the drawings. Apparently, the described embodiments are only a part of the embodiments of the present disclosure, not all of the embodiments. All of other embodiments which are obtained by those skilled in the art based on the embodiments of the present disclosure without creative effort will fall within the scope of the present disclosure.

The embodiments of the present disclosure disclose a method, a system and a mobile terminal for deleting a chat record, which is able to selectively delete chat records, thus prevent losses of a user. Those will be described below in detail, respectively.

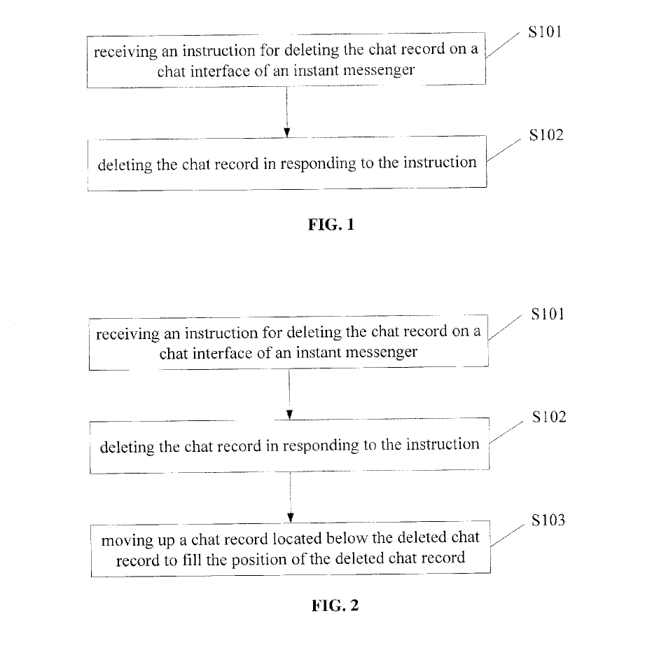

Referring to FIG. 1, which is a flowchart of a method for deleting a chat record according to an embodiment of the present disclosure. As shown in FIG. 1, the method for deleting a chat record may include steps S101 to S102.

Step S101 may include receiving an instruction for deleting the chat record on a chat interface of an instant messenger.

In an embodiment of the present disclosure, the instruction is trigger-input by an operation from a user to any of the chat records on the chat interface of the instant messenger, where the chat interface of the instant messenger is trigger-entered after the user logs in the instant messenger on a mobile terminal using account information.

In an embodiment of the present disclosure, after logging in the instant messenger, on the mobile terminal using account information (including a user identification and a password, where the user identification may be a account number or a user name), the user may trigger-enter the chat interface of the instant messenger, and thus the user can operate any of the chat records on the chat interface of the instant messenger (for example, any of the chat records from a certain friend, a group or a discussion group) to trigger-input the instruction to the mobile terminal. Accordingly, the mobile terminal can receive the instruction which is trigger-input by an operation from the user to any of the chat records on the chat interface of the instant messenger.

In an embodiment of the present disclosure, the mobile terminal may be a smart phone (Android mobile phone, iOS mobile phone, etc.), a tablet computer or a Mobile Internet Device (MID). The embodiment of the present disclosure is not limited thereto.

In an embodiment of the present disclosure, the mobile terminal may receive the instruction which is trigger-input when the user clicks, double-clicks or long-presses any of the chat records on the chat interface of the instant messenger.

Alternatively, in an embodiment of the present disclosure, the mobile terminal may receive the instruction which is trigger-input when the user drags any of the chat records on the chat interface of the instant messenger out of the chat interface of the instant messenger. The embodiment of the present disclosure is not limited thereto.

Step S102 may include deleting the chat record in responding to the instruction.

In an embodiment of the present disclosure, after the mobile terminal receives the instruction which is trigger-input by an operation from the user to any of the chat records on the chat interface of the instant messenger, the mobile terminal may directly delete the chat record in responding to the instruction.

Alternatively, in an embodiment of the present disclosure, the mobile terminal may receive the instruction which is trigger-input by an operation from the user to any of the chat records on the chat interface of the instant messenger, the mobile terminal may respond to the instruction and output a chat record deletion option. If an operation that the user selects the chat record deletion option is detected, the chat record is deleted. Whereas, if an operation that the user selects the chat record deletion option is not detected, no operation is performed to the chat record.

In the method for deleting a chat record illustrated in FIG. 1, the user may trigger-enter the chat interface of the instant messenger after logging in the instant messenger on the instant messenger on the mobile terminal using account information. And when the mobile terminal receives an instruction for deleting a chat record, the mobile terminal may respond to the instruction and delete the chat record. Therefore, compared with the prior art in which the chat records are deleted in batches, the method for deleting a chat record illustrated in FIG. 1 can selectively delete chat records, and thus can prevent losses of a user.

Referring to FIG. 2, which is a flowchart of another method for deleting a chat recording to an embodiment of the present disclosure. Compared with the method for deleting a chat record illustrated in FIG. 1, the method according to the embodiment further includes:

Step S103 including moving up a chat record located below the deleted chat record to till the position of the deleted chat record.

In the method for deleting a chat record illustrated in FIG. 2, the user may trigger-enter the instant messenger chat interface after logging in the instant messenger on the mobile terminal using account information. And when the mobile terminal receives an instruction for deleting a chat record, the mobile terminal may delete the chat record in responding to the instruction, and move up the chat record located below the deleted chat record to fill the position of the deleted chat record. Therefore, compared with the prior art in which the chat records are deleted in batches, the method for deleting a chat record illustrated in FIG. 2 can selectively delete chat records, and thus can prevent causing losses of a user.

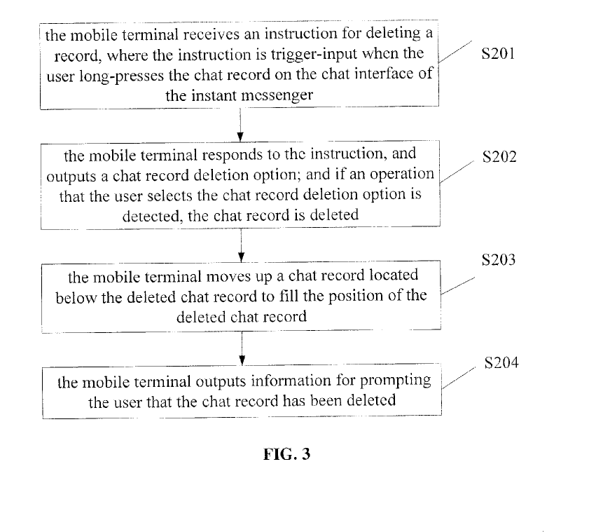

Referring to FIG. 3, which is a flowchart of another method for deleting a chat record according to an embodiment of the present disclosure. As shown in FIG. 3, the method for deleting a chat record may include steps S201 to S204.

Step S201 may include the mobile terminal receiving an instruction for deleting a record, where the instruction is trigger-input when the user long-presses the chat record on the chat interface of the instant messenger.

In an embodiment of the present disclosure, as shown in FIG. 3, the mobile terminal may receive the instruction for deleting a chat record, where the instruction is trigger-input when the user long-presses the chat record “password is 234abc” on the chat interface of the instant messenger.

Step S202 may include the mobile terminal outputting a chat record deletion option in responding to the instruction; and if an operation that the user selects the chat record deletion option is detected, deleting the chat record.

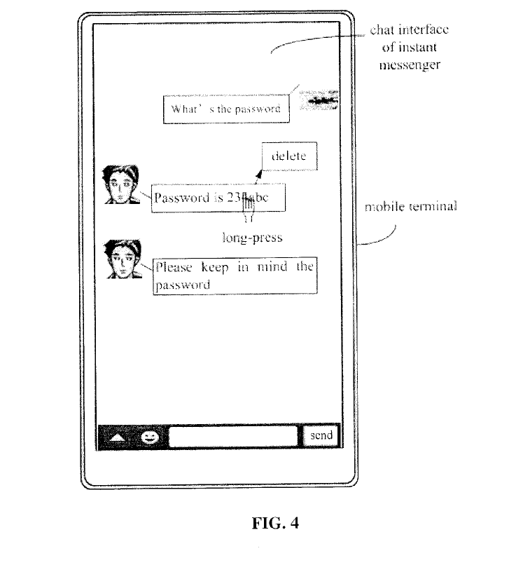

In the embodiment of the present disclosure, as shown in FIG. 4, after the instruction which is trigger-input when the user long-presses the chat record “the password is 234abc” on the chat interface of the instant messenger is transmitted to the mobile terminal, the mobile terminal may respond to the instruction and output the chat record deletion option. When the mobile terminal detects that the chat record deletion option is selected by the user, the mobile terminal may delete the chat record “the password is 234abc”.

In the embodiment of the present disclosure, if the mobile terminal does not detect that the chat record deletion option is selected by the user, no operation is performed to the chat record “the password is 234abc”.

In the embodiment of the present disclosure, after the mobile terminal receives the instruction which is trigger-input by an operation from the user to any of the chat records on the instant messenger chat interface, the mobile terminal may also directly respond to the instruction and delete the chat record, the embodiment of the present disclosure is not limited thereto.

Step S203 may include the mobile terminal moving up a chat record located below the deleted chat record to Fill the position of the deleted chat record.

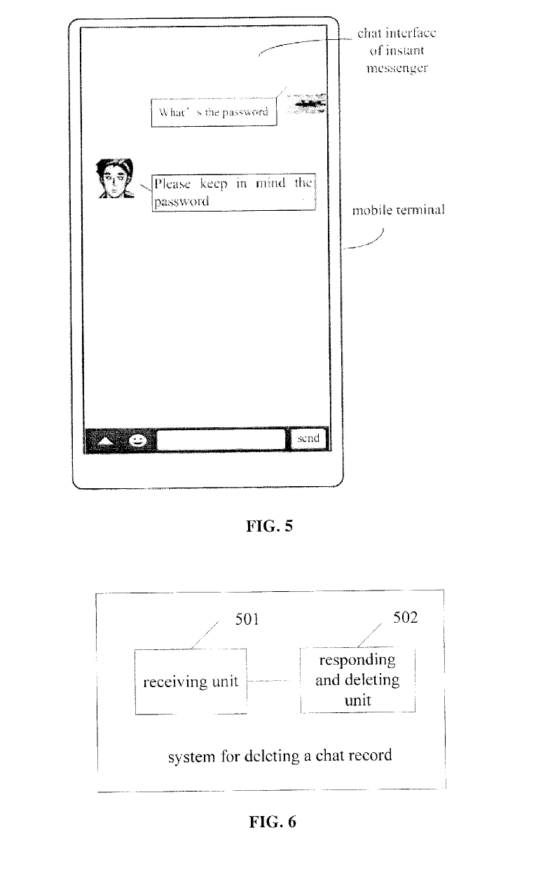

In an embodiment of the present disclosure, as shown in FIG. 5, after the mobile terminal deletes the chat record “the password is 234abc”, the mobile terminal may move up the chat record located below the deleted chat record “the password is 234abc” to fill the position of the deleted chat records “the password is 234abc”.

Step S204 may include the mobile terminal outputting information for prompting the user that the chat record has been deleted.

In the embodiment of the present disclosure, the mobile may output animation information for prompting the user that the chat record is deleted, such as the animation information similar to file shredder, or fade-out disappear gradually. Alternatively, the mobile may output voice information for prompting the user that the chat record has been deleted, for example the voice of “dingdong”, the embodiment of the disclosure is not limited thereto.

In an embodiment of the present disclosure, the sequence between the above steps S203 and 5204 may be reversed, and also the step S203 and the step S204 may be executed simultaneously, the embodiment of the present disclosure is not limited thereto.

In the method for deleting a chat record as illustrated in FIG. 3, the user may trigger-enter the chat interface of the instant messenger after logging in the instant messenger on the mobile terminal using account information. And when the mobile terminal receives an instruction for deleting a chat record, where the instruction is trigger-input by an operation from the user to any of the chat records on the instant messenger chat interface; the system may respond to the instruction and delete the chat record, and move up a chat record located below the deleted chat record to fill the position of the deleted chat record. Furthermore, the mobile terminal may notify the user of the deletion of the chat record. Therefore, compared with the prior art in which the chat records are deleted in batches, the method for deleting a chat record as illustrated in FIG. 3 can selectively delete a chat record, and thus can prevent causing losses to the user.

Referring to FIG. 6, which is a structure diagram of a system for deleting a chat record according to an embodiment of the present disclosure. The system for deleting a chat record according to the embodiment of the disclosure may be used in smart phones (Android mobile phones, iOS mobile phones, etc.), tablet computers and other MID, the embodiment of the present disclosure is not limited thereto. As shown in FIG. 5, the system for deleting a chat record according to the embodiment of the present disclosure may include a receiving unit 501, and a responding and deleting unit 502.

The receiving unit 501 is configured to receive an instruction for deleting the chat record.

In an embodiment of the present disclosure, the instruction is trigger-input by an operation from a user to any of the chat records on the chat interface of an instant messenger, where the chat interface of the instant messenger is a chat interface which is trigger-entered after the user logs in the instant messenger on the mobile terminal using the account information;

The responding and deleting unit 502 is configured to respond to the instruction and delete the chat record.

In an embodiment of the present disclosure, the receiving unit 501 is configured to receive an instruction for deleting a chat record, where the instruction is trigger-input when the user clicks, double-clicks or long-presses any of the chat records on the chat interface of an instant messenger; alternatively, the receiving unit 501 is configured to receive an instruction for deleting a chat record, where the instruction is trigger-input when the user drags any of the chat records on the chat interface of an instant messenger out of the chat interface of the instant messenger, the embodiment of the present disclosure is not limited thereto.

In an embodiment of the present disclosure, the responding and deleting unit 502 is configured to respond to the instruction and output a chat record deleting option; where if an operation that the user selects the chat record deleting option is detected, the chat record is deleted; if an operation that the user selects the chat record deleting option is not detected, no operation is performed to the chat record.

In an embodiment of the present disclosure, the responding and deleting unit 502 may also respond to the instruction and delete the chat record directly, the embodiment of the disclosure is not limited thereto.

Therefore, compared with the prior art in which the chat records are deleted in batches, the system for deleting a chat record illustrated in FIG. 6 can selectively delete the chat records, and thus can prevent causing losses to the user.

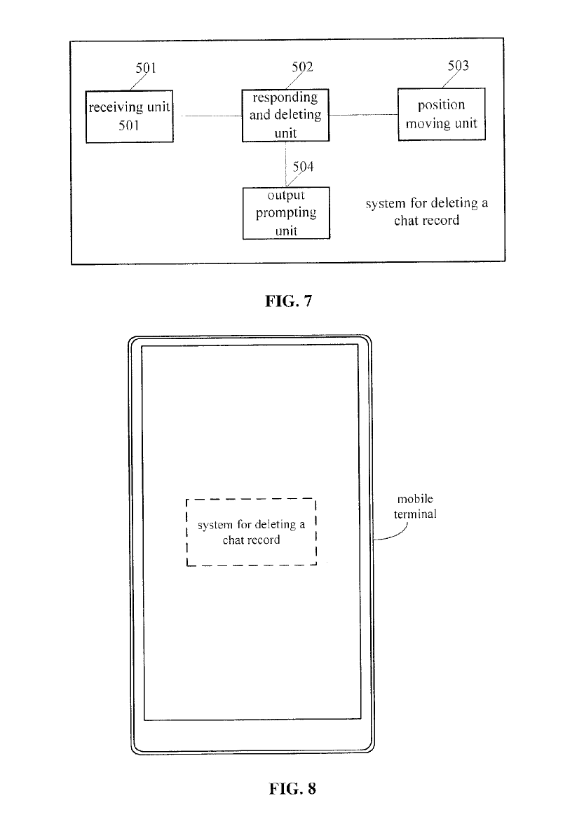

In an embodiment of the present disclosure, as shown in FIG. 7, the system further includes: a position moving unit 503, configured to move up a chat record located below the deleted chat record to fill the position of the deleted chat record.

In an embodiment of the present disclosure, as shown in FIG. 7, the system further includes:

An output prompting unit 504, configured to output information for prompting the user that the chat record has been deleted after the responding and deleting unit 502 deletes the chat record.

In an embodiment of the present disclosure, the output prompting unit is configured to output animation information or voice information for prompting the user that the chat record has been deleted after the responding and deleting unit 502 deletes the chat record.

Therefore, compared with the prior art in which the chat records are deleted in batches, the system for deleting a chat record illustrated in FIG. 7 can selectively delete the chat records, and thus can prevent losses of the user.

Referring to FIG. 8, which is a structure diagram of a mobile terminal according to an embodiment of the present disclosure. As shown in FIG. 8, the mobile terminal according to the embodiment of the present disclosure may include the system for deleting a chat record shown in FIG. 6. In the embodiment of the present disclosure, a related terminal may be a smart phone (an Android mobile phone, an iOS mobile phone, etc.), a tablet computer or other MID, the embodiment of the disclosure is not limited thereto. Compared with the prior art in which the chat records are deleted in batches, the mobile terminal illustrated in FIG. 8 can selectively delete the chat records, and thus can prevent causing losses to the user.

It may be understood by those skilled in the art that all or part of the steps in various methods according to the embodiments described above may be implemented by instructing relevant hardware using a program. The program may be stored in a computer readable storage medium. The storage medium may include: flash disk, Read-Only Memory (ROM), Random Access Memory (RAM), magnetic disk or compact disk, etc.

A method, a system and a mobile terminal for deleting a chat record according to the embodiments of the present disclosure have been described above in detail. The principle and embodiments of the present disclosure are set forth by using some specific example herein, and the explanations for the embodiment described above are only used to help understand the method and the core concept of the present disclosure. Meanwhile, for those skilled in the art, changes may occur on the specific embodiment and the application range according to the idea of the present disclosure. Therefore, the specification should not be understood as a limitation to the present disclosure.

1. A method for deleting a selected chat record, comprising:
receiving, by a device comprising a processor, an instruction to delete the selected chat record from a batch, the batch having a plurality of chat records; and
deleting, by the device, the selected chat record in responding to the instruction.

2. The method according to claim 1, further comprising:
moving up a chat record located below the deleted chat record to fill the position of the deleted chat record.

3. The method according to claim 1, wherein the instruction to delete the selected chat record is trigger-input by an operation from a user of the chat records on a chat interface in an instant messenger.

4. The method according to claim 3, wherein the chat interface of the instant messenger is trigger-entered after the user logs in the instant messenger on a mobile terminal using account information.

5. The method according to claim 3, wherein receiving an instruction to delete the selected chat record comprises:
receiving the instruction when the user clicks, double-clicks or long-presses the selected chat record on the chat interface of the instant messenger.

6. The method according to claim 3, wherein receiving an instruction to delete the selected chat record comprises:
receiving the instruction when the user drags the selected chat record on the chat interface of the instant messenger out of the chat interface of the instant messenger.

7. The method according to claim 1, wherein deleting the selected chat record in responding to the instruction comprises:
outputting a chat record deletion option in responding to the instruction; and
deleting the selected chat record when the user selects the chat record deletion option.

8. The method according to claim 1, further comprising:
outputting information for prompting the user that the selected chat record is deleted.

9. The method according to claim 8, wherein the outputting information for prompting the user that the selected record is deleted comprises at least one of:
outputting animation information for prompting the user that the selected chat record is deleted; and
outputting voice information for prompting the user that the selected chat record is deleted.

10. A system for deleting a selected chat record, comprising:
a receiving unit, configured to receive an instruction for deleting the selected chat record from a batch, the batch having a plurality of chat records; and
a responding and deleting unit, configured to delete the selected chat record in responding to the instruction.

11. The system according to claim 10, further comprising:
a position moving unit, configured to move up a chat record located below the deleted chat record to fill a position of the deleted chat record.

12. The system according to claim 10, wherein the receiving unit is configured to receive the instruction which is trigger-input when a user clicks, double-clicks or long-presses the selected chat record on a chat interface of an instant messenger.

13. The system according to claim 10, wherein
the receiving unit is configured to receive the instruction which is trigger-input when a user drags the selected chat record on a chat interface of an instant messenger out of the chat interface of the instant messenger.

14. The system according to claim 10, wherein the responding and deleting unit is configured to: output a chat record deletion option in responding to the instruction; and delete the selected chat record if the user selects the chat record deletion option.

15. The system according to claim 10, further comprising:
an output prompting unit, configured to output information for prompting the user that the selected chat record is deleted after the responding and deleting unit deletes the selected chat record.

16. The system according to claim 15, wherein the output prompting unit is configured to output at least one of animation information and voice information for prompting the user that the selected chat record is deleted after the responding and deleting unit deletes the selected chat record.

17. A mobile terminal comprising a system for deleting a selected chat record, wherein the system comprises:
a receiving unit, configured to receive an instruction for deleting a selected chat record from a batch, the batch having a plurality of chat records; and
a responding and deleting unit, configured to delete the selected chat record in responding to the instruction.

18. The mobile terminal of claim 17, wherein the system further comprises a position moving unit configured to move up a chat record located below the deleted chat record to fill a position of the deleted chat record.

19. The mobile terminal of claim 17, wherein the system further comprises an output prompting unit configured to output information for prompting the user that the selected chat record is deleted after the responding and deleting unit deletes the selected chat record.

20. The mobile terminal of claim 19, wherein the output prompting unit is configured to output at least one of animation information and voice information for prompting the user that the selected chat record is deleted after the responding and deleting unit deletes the selected chat record.
